(19) United States
(12) Patent Application Publication
(10) Pub. No.: US 2007/0151613 A1
(43) Pub. Date: Jul. 5, 2007

(54) Sanitary fitting

(76) Inventors: Arno Hahn, Schiltach (DE); Joachim Blattner, Haslach (DE)

Correspondence Address: DUANE MORRIS, LLP;IP DEPARTMENT, 30 SOUTH 17TH STREET, PHILADELPHIA, PA, 19103-4196, US

(21) Appl. No.: 10/597,151

(22) PCT Filed: Dec. 23, 2004
(86) PCT No.: PCT/EP04/14660

§ 371 Date: Nov. 27, 2006

(30) Foreign Application Priority Data
Jan. 14, 2004 (DE) 10 2004 003 133.9

(51) Int. Cl. F16K 11/078

(52) U.S. Cl. 137/625.4

(57) ABSTRACT

In the case of a sanitary fitting, an operating grip is pushed on the operating shaft of a mixer cartridge. To fix the operating grip a locking device is proposed, which engages on the locking element located on the operating grip by means of a locking element on the fitting. There is as such no direct security lock between the grip and operating shaft, but between operating grip and valve body.

The invention relates to a sanitary fitting by which a mixer cartridge is fitted inside a valve body. Such mixer cartridges are known. They are provided with a mixer system which helps water to be mixed and volumetric flow rate controlled, and which can be operated with the help of an operating shaft mounted in the cartridge. The operating shaft is drawn out of the cartridge. An operating grip or lever is mounted on the operating shaft that is designed according to optic and aesthetic requirements.

In the case of newer sanitary fittings, the operating grips are also known, which are designed as short rods, so-called joysticks.

To fasten the operating grips on the operating shaft of the mixer cartridge, it is known to accommodate a clamping screw in the operating grip, which is firmly screwed on the operating shaft, so that the grip is clamped. To improve the connection, the shaft can also feature a notch in which the clamping screw engages in order to prevent the grip from becoming loose. This clamping screw should not be visible from outside. For this reason is it often necessary to cover the opening through which the clamping screw is accessible.

Particularly in small operating grips shaped as joysticks, the clamping screw must also be very small because only little space is available therefore.

All mounting methods of this type are problematic since the clamping screws are very small, special tools are often required, and there is danger of them getting lost. Furthermore, there is danger that the screw connection may become loose in the course of time, which can cause limitations to the operator of the valve.

In a familiar grip fixation (EP 579 111), the operating shaft of the mixer cartridge is firmly screwed into a flange element that is then inserted into a grip cap and secured in place with a grub screw.

In a further single-lever mixer (DE 38 15 901) a grip is snapped on the free end of the operating shaft grip. The operating shaft features lateral depressions in the elastic protrusion of the grip snap-in part.

In yet a further mixing valve (U.S. Pat. No. 4,960,154), a grip is fixed on the operating shaft, in that the operating shaft is inserted into a blind hole of the grip and firmly clamped with a radial clamping screw.

The invention is based on the task to provide a fastening means for a mixer grip that is easy to manufacture and assemble and with which the disadvantages of the state of the art mentioned above do not exist.

To solve this task, the invention proposes a sanitary fitting with the features mentioned in claim 1. Further embodiments of the invention are subject matter of subordinate claims.

Although all familiar methods of fixing the grip on a mixer cartridge feature a locking element that always acts directly between the grip and the shaft, the invention applies a different method. Together, they do not place the locking elements forming the locking device between the grip and the shaft, but between the grip and another part relative to which the mixer cartridge is fixed. This makes it possible that the locking elements must not be adjusted to the size of the operating shaft since the operating shafts are relatively small and are weakened further by the notches or other similar cross-section reductions.

A possibility of how the locking device can be formed comprises positioning one of the locking elements on the operating grip, while the other locking element is assigned to the valve body. Even in very small, especially very narrow, operating grips it is possible to form the operating grip at a position, where it is necessarily visible, such that enough material is available for holding the locking device.

Particularly, in further development of the invention, it can be made possible that the locking element assigned to the valve body is a part of the fastener of the mixer cartridge.

It is also possible and has been proposed by the invention that the locking element or fixing element provided for the valve body is a part of the valve body itself.

For instance, this locking element can be part of the outlet of the sanitary fitting.

It can be provided that, the locking element assigned to the valve body is a sleeve. For instance, in combination with a part of the valve body, for example the outlet of the sanitary fitting, this can also serve for positioning and fixing the mixer cartridge inside the valve body.

In particular, the locking element can be provided to the valve body as a union nut that is likewise provided, for instance, for determining and fixing the mixer cartridge directly or over a sleeve.

The locking element assigned to the operating grip can for instance be a flange. The same can be assigned to the end of the operating shaft facing the mixer cartridge, so that it does not disturb optically. Dependent on how the mixer cartridge is operated, based on further development of the invention, it can be made possible that the surface of the flange facing away from the mixer cartridge is a part of a cylindrical surface or a spherical surface. When the mixer cartridge is operated by swiveling the operating shaft around a fixed axis, a cylindrical surface is the preferred formation proposed by the invention. When in contrast, as is mostly the case, the operating shaft can be swiveled around a fixed point in different directions, then the possibility preferred by the invention is the spherical surface of the flange.

In the case of mixing valves according to the state of the art, the grip is generally formed such that it optically covers the area in which the operating shaft protrudes out of the cartridge and out of the valve body. In the case of very small rod-like operating grips, the flange just mentioned and proposed by the invention can perform this task. Preferably, the sanitary fitting is formed such that the flange covers the passage opening of the operating shaft in all possible positions of the mixer cartridge. Thereby, the cover can especially take place in interaction with the locking element assigned to the valve body.

To prevent cleaning agents from penetrating into the sanitary fitting according to the invention, a seal can be provided between the locking elements that together form the locking device. This seal can particularly be fixed or located on the locking element on the side of the sanitary fitting. It can especially be a part of a fastening element.

To improve handling of the sanitary fitting, it can be provided that, the seal features an equal area along which the respective other locking element slides.

The locking device serves to secure the operating grip against removal or detachment from the operating shaft. It is not necessary for the locking device to secure the operating grip also against rotation relative to the operating shaft. In case this is desired, such security against rotation can be achieved by appropriately forming the operating shaft and grip. The grip, similarly to the state of the art, is thereby connected with the operating shaft such that it is stuck on the operating shaft in the axial direction thereof. For this purpose, the operating grip normally has a cavity, for instance, which can be formed as a sleeve element with one closed side.

Further features, details and preferences of the invention ensue from the patent claims and the abstract, by both of which the wording is based on reference to the content of the following description of the preferred exemplary embodiments of the invention and by means of the drawing. Hereby the following are shown:

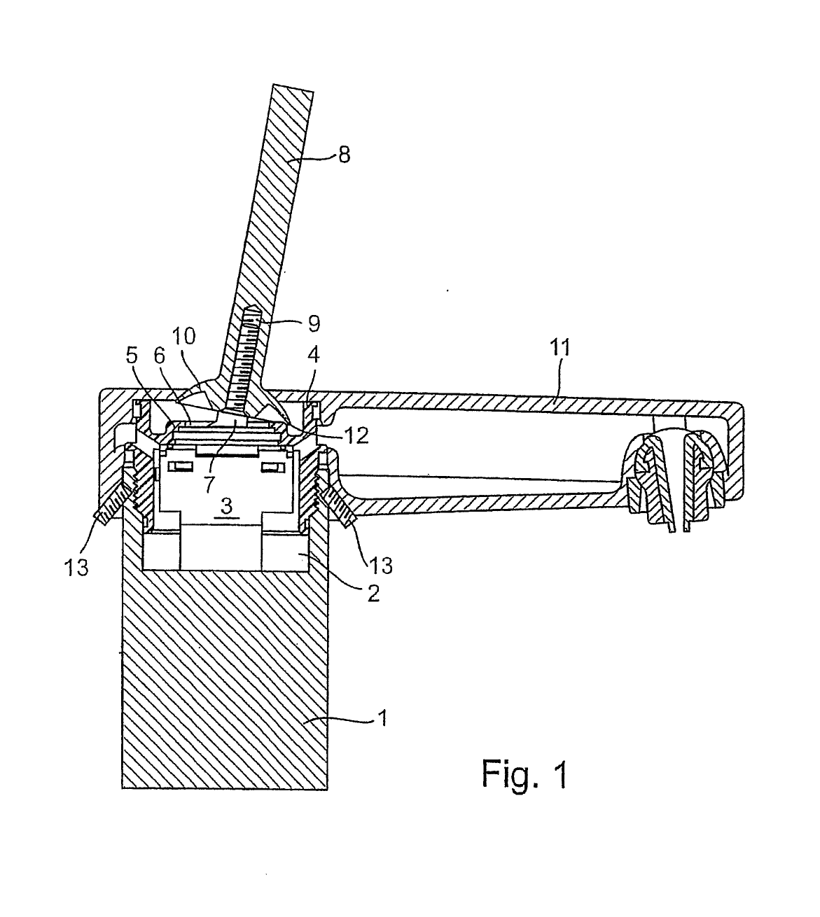

FIG. 1 a schematic section through a sanitary fitting according to the invention;

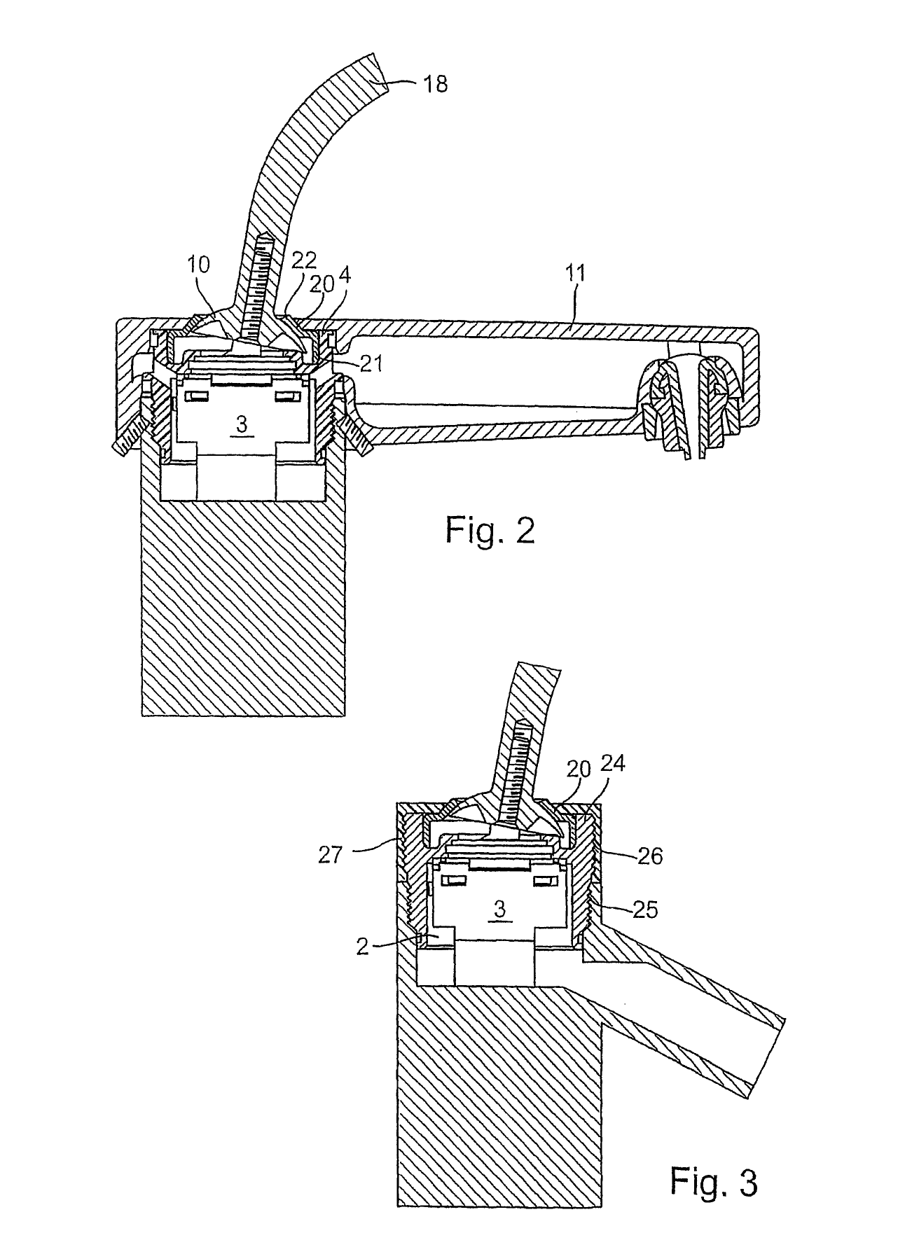

FIG. 2 a depiction of a second exemplary embodiment according to FIG. 1;

FIG. 3 a depiction of a third exemplary embodiment according to FIGS. 1 and 2;

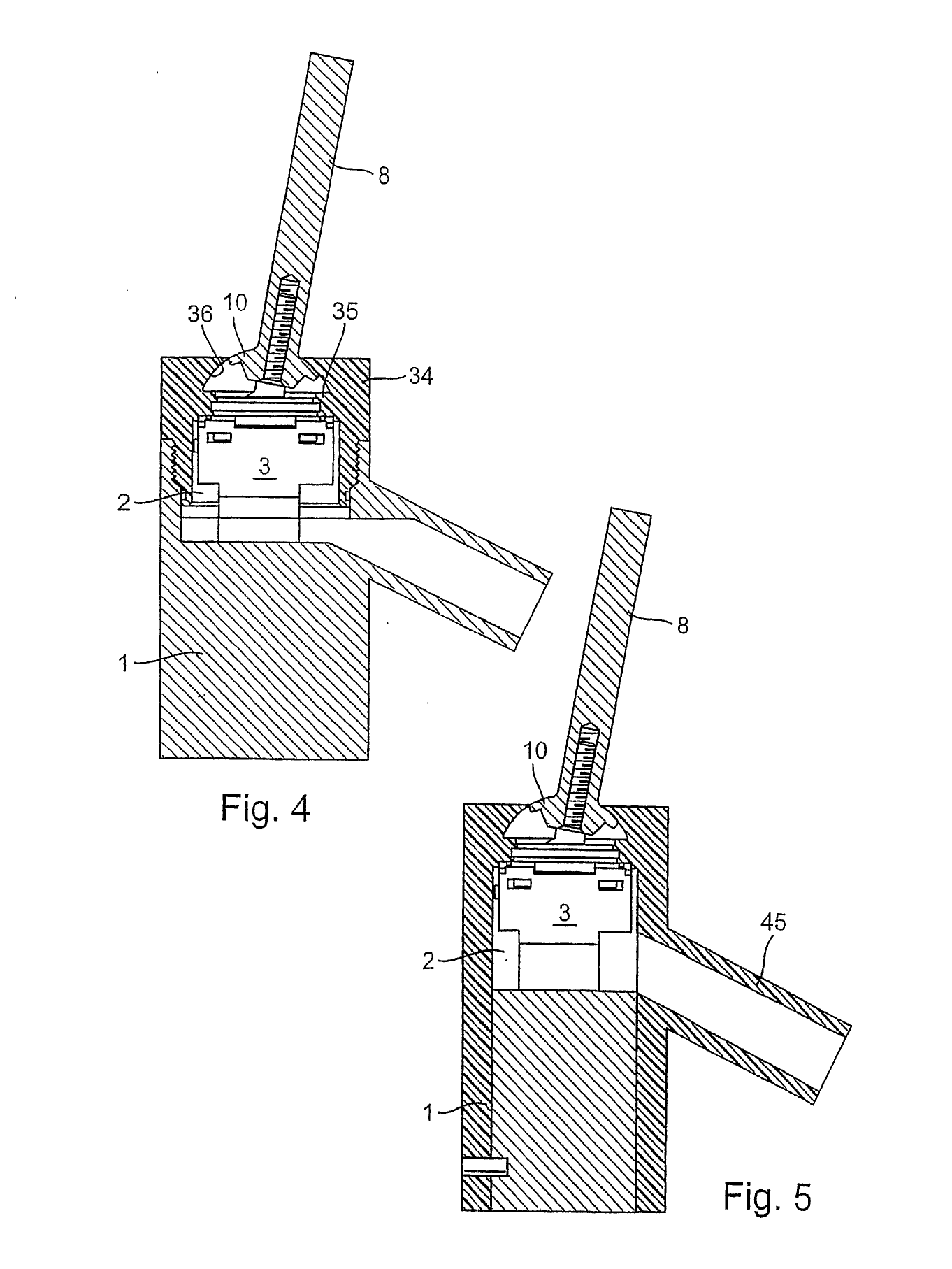

FIG. 4 a schematic section through a sanitary fitting according to a further exemplary embodiment;

FIG. 5 a schematic section through a sanitary fitting in a yet further exemplary embodiment of the invention.

FIG. 1 shows a very simple section through a sanitary fitting. The lower part of the valve body 1 is only depicted schematically, since the details are not decisive. In the valve body 1 a cavity 2 is formed, a mixer cartridge 3 is provided in said cavity. The mixer cartridge is inserted into the cavity 2 with open top, and centered and positioned there by means of a sleeve 4. The sleeve 4 features a partition wall in which a central opening 6 is provided. This partition wall lies on the upper edge of the mixer cartridge 3. An operating shaft 7 protrudes out of the mixer cartridge 3, which is provided with longitudinal tooth.

When the mixer cartridge 3 and the sleeve 4 are inserted into the cavity 2, an operating grip 8 is pushed on the operating shaft 7. This operating grip 8 features a central opening 9 in form of a blind hole, whose edges can likewise feature a longitudinal tooth. It is also possible that longitudinal tooth is first cut while pushing the operating grip 8 over the operating shaft 7 of the mixer cartridge 3. The connection in rotation direction can also be achieved by means of a form-fit designed otherwise.

In the area of its lower end that faces the mixer cartridge 3, the operating grip 8 contains a flange 10 aligned outwards, by which the surface lies in a spherical surface. The middle point of this imaginary sphere lies in the middle point of the pivot of the operating shaft 7. By swiveling the operating shaft 7 with the help of the operating grip 8, the surface of the flange 10 remains in the solid spherical surface.

The valve body contains an outlet 11 that is formed in outlet housing. This outlet 11 contains an opening 12 in its top side, by which the edge likewise lies in a spherical surface. The edge of the opening 12 is and appears undercut, when viewed from top. If now the outlet 11 with its opening 12 is threaded onto the operating grip 8 and on the top side of other valve body 1, then the surface of the flange 10 lies flat on the edge of the opening 12 of the outlet 11. In this position, the outlet 11 is fixed with the help of two screws 13. In the case of a swiveled operating grip 8, the spherical surface of the flange 10 lies on the complementarily formed opening 12 of the outlet 11.

The means of fixing the outlet 11 simultaneously serves for fixing the sleeve 4, and therefore the mixer cartridge 3 in the valve body 1 via the partition wall 5. The security against pull-off is ensured through the contact between the spherical surface of the flange 10 and the edge of the opening 12. The contact with the operating grip 8 in circumferential direction is established through the longitudinal tooth of the operating shaft 7.

FIG. 2 shows a modified exemplary embodiment, with which only the parts are described in detail, which differ from those of the exemplary embodiment according to FIG. 1. A sleeve 4 again serves for positioning the mixer cartridge 3, which, just like the sleeve 4 of the exemplary embodiment according to FIG. 1, is open towards the top. In this open-top end of the sleeve 4 a lid element 20 is inserted from top, which with its cylindrical lower edge 21 on the inner side of the sleeve 4 lies above the partition wall 5. In the middle area, the lid element 20 features an opening 22, which acquires an edge with enlarged rake, by bending the material. The rake aligned inwards of this enlarged edge zone lies on a spherical surface, which is complementary to the spherical surface of the flange 10 of the operating grip 18. The outlet 11 is then mounted on this unit. The outlet 11, which is fixed in the same manner just like the exemplary embodiment according to FIG. 1, presses the lid element 20 in the sleeve 4 and ensures that the operating grip 18 is secured against pull-off. The lid element 20 with its edge area around the opening 22 forms an enlarged locating face, which can also be used to form a seal. The lid element 20 can comprise a rubber-elastic flexible material and form a sealing element. This sealing element can be provided on the surface with a sliding face lying opposite the movable part. It is also possible that the lid element 20 is only used for the improvement of sliding properties and for enlarging the rake without possessing sealing properties. The lid element 20 can comprise both plastic and metal.

In the case of the exemplary embodiment depicted in FIG. 3, the mixer cartridge is held in the cavity 2 by means of a sleeve 24, which is designed similar to the sleeve 4 in the exemplary embodiments according to FIGS. 1 and 2, but is nonetheless screwed in the valve body 1. The upper inner edge of the cavity 2 features an internal thread 25 in which the sleeve 24 is screwed until it lies with one shoulder on the corresponding opposite shoulder of the valve body. In the upper section, the sleeve 24 features a further outside thread 26, which is further outwards than the first thread. In the top open end of the sleeve 24, the same lid element 20 is fitted as in the case of the exemplary embodiment according to FIG. 2. An external cap 27 serves for fixing, which features an opening 12 of the outlet 11 in the case of the exemplary embodiment according to FIGS. 1 and 2.

The cap is screwed on the outside thread 26 of the sleeve 24. It fixes the lid element 20 in the same manner as in the case of the exemplary embodiment according to FIG. 2.

In FIG. 4, a cap 34 is used to fix the mixer cartridge 3 inside the cavity 2 of the valve body 1. This assumes the role of the sleeve 4 or 24 in its lower section, in the exemplary embodiments according to FIGS. 1 to 3 and forms the locking element in its upper section of the locking device for flange 10 of the operating grip 8. For the purpose, the cap 34 has a cavity above the outlined partition wall 35; same cavity is closed upwards by a spherical surface 36, in which a passage for the operating grip 8 is provided in the middle. Here the lock of the grip is secured against pull-off via the interaction between the surface of the flange 10 and an opposite surface formed in the cap 34.

In the case of the exemplary embodiment according to FIG. 5, not only the sleeve 4 or 24, but also the side wall of the cavity 2 for the mixer cartridge 3 is formed by the valve body 1, which simultaneously also features an outlet. In the upper section, the valve body 1 is designed like the cap 34 in the exemplary embodiment according to FIG. 4.

The principle idea of the invention is to fix the operating grip or to secure the grip against pull-off from the operating shaft on which it is fitted. To use a locking device that does not act directly between the grip and the shaft, but acts between the grip and another part of the sanitary fitting, preferably a part of the valve body that can simultaneously serve also for securing the mixer cartridge in the valve body.

What is claimed is:

1. Sanitary fitting, with
a valve body,
a mixer cartridge located in the valve body, and an operating shaft associated with the mixer cartridge,
an operating grip for operating the mixer cartridge, wherein the operating grip can be connected with the operating shaft of the mixer cartridge,
a locking device for connecting the operating grip with the operating shaft, secure against removal, said locking device being formed such that the locking device does not act between the operating grip and the operating shaft.

2. Sanitary fitting according to claim 1, wherein the locking device at least comprises two interacting locking elements, one of said locking elements being provided on the operating grip and another of said locking elements being provided on the valve body.

3. Sanitary fitting according to claim 2, wherein the locking element located on the valve body forms a part of a means for fixing the mixer cartridge.

4. Sanitary fitting according to claim 2, wherein the locking element located on the valve body is a part of the valve body.

5. Sanitary fitting according to claim 2, wherein the locking element located on valve body is a part of an outlet of the sanitary fitting.

6. Sanitary fitting according to claim 2, wherein the locking element located on valve body comprises a sleeve.

7. Sanitary fitting according to claim 2, wherein the locking element located on valve body comprises a union nut.

8. Sanitary fitting according to claim 2, wherein the locking element located on the operating grip comprises a flange.

9. Sanitary fitting according to claim 2, wherein a surface facing away from the mixer cartridge on the locking element of the operating grip is a part of one of a cylindrical surface and a spherical surface.

10. Sanitary fitting according to claim 8, wherein the flange is formed such that the flange covers a passage opening for the operating shaft.

11. Sanitary fitting according to claim 2, further comprising a seal located between the two locking elements of the locking device.

12. Sanitary fitting according to claim 11, wherein the seal is fitted on a side of one of the locking elements.

13. Sanitary fitting according to claim 11, wherein the seal comprises a section with a sliding surface finish.

14. Sanitary fitting according to claim 1, wherein the fixing means of the operating grip on the operating shaft is arranged on a circumference around the operating grip and the operating shaft.

15. Sanitary fitting according to claim 3, wherein the locking element located on the valve body is a part of the valve body.

16. Sanitary fitting according to claim 2, wherein the locking element located on valve body is a part of an outlet of the sanitary fitting and a part of one of the valve body and a means for fixing the mixer cartridge.

17. Sanitary fitting according to claim 10, wherein the flange covers the passage opening for the operating shaft in all possible positions of the mixer cartridge.
